(19) United States
(12) Patent Application Publication
(10) Pub. No.: US 2011/0005968 A1
(43) Pub. Date: Jan. 13, 2011

(54) Coking Process Additives and Related Processes

(75) Inventors: Sudhakar Chakka, Naperville, IL (US); Bang Xu, Naperville, IL (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/498,497

(22) Filed: Jul. 7, 2009

(51) Int. Cl. C10L 1/00; C10G 11/00; C10G 9/00; C01B 31/24; C01B 13/14

(52) U.S. Cl. 208/14; 208/131; 208/106; 423/420.2; 423/592.1

(57) ABSTRACT

This invention relates to coking process additives and, related processes, such as upgrading heavy hydrocarbons, producing petroleum coke and lighter hydrocarbon products, and/or thermally cracking heavy hydrocarbons. The additive includes an anionic clay to increase a liquid product yield. Suitable anionic clays may include hydrotalcite materials and hydrotalcite-like materials.

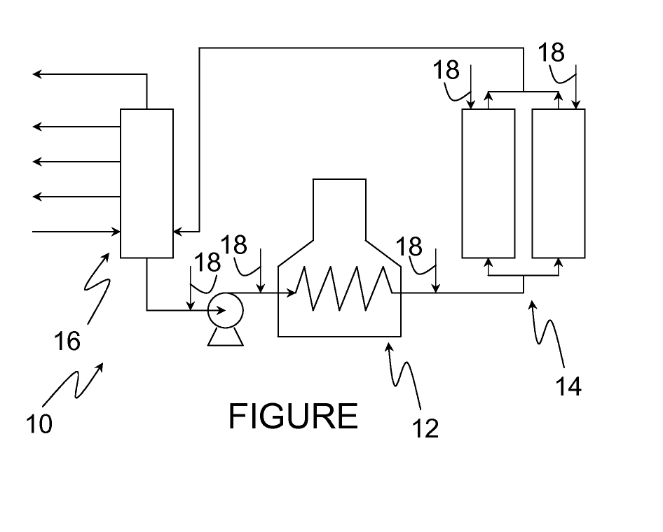

### BACKGROUND

1. Technical Field

This invention relates to coking process additives and related processes, such as upgrading heavy hydrocarbons, producing petroleum coke and lighter hydrocarbon products, or thermally cracking heavy hydrocarbons.

2. Discussion of Related Art

Modern refineries include many units and/or process blocks, such as crude distillation units, hydrotreating units, fluidized catalytic cracking units, residue fluidized catalytic cracking units, delayed coking units, continuous coking units, hydrocracking units, visbreaking units, and/or the like.

However, even with the above technology in modern refineries, there remains a need and a desire to for hydrocarbon conversion processes that enhance a liquid product yield, lower a coke yield, or change a coke product morphology.

### SUMMARY

This invention relates to coking process additives and related processes, such as upgrading heavy hydrocarbons, producing petroleum coke and lighter hydrocarbon products, and/or thermally cracking heavy hydrocarbons. The additives and processes of this invention can enhance a liquid product yield, lower a coke yield, and/or change a coke (solid) product morphology.

According to a first embodiment, this invention includes a coking process additive. The additive includes an anionic clay to increase a liquid product yield. Suitable anionic clays may include hydrotalcite materials and hydrotalcite-like materials.

According to a second embodiment, this invention includes a process of upgrading heavy hydrocarbons and producing petroleum coke. The process includes the step of mixing an anionic clay coking process additive with a hydrocarbon stream, and the step of coking the hydrocarbon stream to form a solid product, a liquid product, and a gas product.

According to a third embodiment, this invention includes a process of thermally cracking heavy hydrocarbons. The process includes the step of mixing an anionic clay process additive with a hydrocarbon stream, and the step of heating the hydrocarbon stream to thermally crack at least a portion of the hydrocarbon stream.

According to a fourth embodiment, this invention includes petroleum coke made by any of the coking process additives, processes of upgrading heavy hydrocarbons and producing petroleum coke, and/or processes of thermally cracking heavy hydrocarbons described herein.

### BRIEF DESCRIPTION OF THE DRAWING

The accompanying drawing, which is incorporated in and constitutes a part of this specification, illustrates embodiments of the invention and, together with the description, serve to explain the features, advantages, and principles of the invention. In the drawings, the FIGURE shows a schematic view of a delayed coking process, according to one embodiment.

### DETAILED DESCRIPTION

This invention relates to coking process additives and related processes, such as upgrading heavy hydrocarbons and producing petroleum coke, or thermally cracking heavy hydrocarbons.

The FIGURE shows a schematic view of a delayed coking process 10, according to one embodiment. The delayed coking process 10 includes a furnace 12 and coke drums 14. The delayed coking process 10 also includes a fractionator 16. The delayed coking process 10 includes one or more injection points 18, such as for additive addition.

According to one embodiment, the invention can include a coking process additive. The additive can include an anionic clay to increase a liquid product yield.

Additive broadly refers to suitable elements, compounds, mixtures, and/or the like, such as to affect a change and/or a difference in a material, a process and/or the like. According to one embodiment, additives can be consumed in processing and/or use, such as not being recoverable and/or reusable.

In contrast, catalysts generally can be recovered and/or reused in subsequent processes, since catalysts by definition don't become consumed in a reaction. Additives may affect reaction rates, such as by lowering an activation energy, shifting equilibrium, reacting with one or more components of the reactant, and/or the like. Additives may also affect a physical phenomena occurring in a process such as by acting as a surfactant, an antiflocculant, and/or the like. According to one embodiment, at least a portion of the additive becomes a part of the solid product and/or petroleum coke, such as being at least generally dispersed within the solid product.

The additive may be in any suitable form, such as a solid, a powder, a finely divided solid, a granule, a pellet, a solution, a suspension, a slurry, a foam, an emulsion, and/or the like. Suitable carrier materials for the additive may include, but are not limited to, hydrocarbons of any suitable boiling range (gas oil, whole crude oil, petroleum residua, and/or the like), oxygenated hydrocarbons, solvents, water, air, nitrogen, argon, hydrogen, carbon dioxide, and/or the like.

The additive may be combined and/or mixed in any suitable amount with a feed stream, such as less than about 50 percent of the feed stream, less than about 25 percent of the feed stream, between about 0.01 percent and about 20 percent of the feed stream, between about 0.1 percent and about 2 percent of the feed stream, and/or the like on a mass basis.

The additive may include any suitable additional molecules and/or compounds, such as cracking catalysts, free radical initiators, free radical inhibitors, anti-flocculants, flocculants, surfactants, hydrogen transfer catalysts, metal oxides, sulfides, organometallic complexes, dispersants, water, hydrogen, carbon monoxide, high molecular weight polymers with oxygen functional groups, metal overbases, metal dispersions, high surface area solids, Lewis acids, oil soluble organometallic compounds of various metals, hydrogen, metal powders, sulfur, sulfur compounds, phosphoric acid, coal, carbon materials, carbonaceous materials, and/or the like.

Process broadly refers to a series of actions, steps, operations and/or the like, such as conducing to an end and/or a goal A process may be discrete, batch, semi-batch, semi-continuous, continuous, and/or the like.

Coking broadly refers to formation and/or production of a solid carbonaceous material, such as by thermal cracking, pyrolysis, destructive distillation, and/or the like. Desirably, coking steps and/or processes produce at least one solid product, at east one liquid product, and at least one gas product. According to one embodiment, coking processes exclude a use of recoverable catalysts. According to one embodiment, coking processes exclude hydrogen addition, such as from an external source.

According to one embodiment, coking processes may include delayed coking, continuous coking, Fluidcoking™ (Fluidcoking is a trademark of ExxonMobil of Irving, Tex., U.S.A.), Flexicoking™ (Flexicoking is a trademark of ExxonMobil of Irving, Tex., U.S.A.), and/or the like. Desirably, but not necessarily, the coking process reduces a molecular size and/or an average molecular weight of a feedstock.

Coking processes may operate at any suitable temperature, such as at least about 100 degrees Celsius, between about 200 degrees Celsius and about 1,000 degrees Celsius, between about 250 degrees Celsius and about 750 degrees Celsius, between about 400 degrees Celsius and about 550 degrees Celsius, and/or the like. The temperate may be measured at any suitable location, such as a coker unit feed, a furnace coil outlet, a coke drum entrance, and/or the like.

Coking processes may operate at any suitable pressure, such as at least about 1 bar absolute, between about 2 bars absolute and about 5 bars absolute, between about 1 bar absolute and about 7 bars absolute, and/or the like.

Anionic broadly refers to elements, molecules, and/or compounds with a full negative charge.

Clay broadly refers to materials and/or substances including fine grained minerals, such as aluminum silicates and other minerals. Clays may include naturally occurring materials, synthetically derived materials, and/or the like. Clays may include phyllosilicates and/or other layered structures.

Increase broadly means to make more of something, such as at least about 0.01 weight percent, at least about 0.1 weight percent, at least about 0.2 weight percent, at least about 0.5 weight percent, at least about 1.0 weight percent, at least about 2.0 weight percent, at least about 5 weight percent, at least about 10 weight percent, at least about 15 weight percent, at least about 20 weight percent, and/or the like.

Solid product broadly refers to products and/or streams having a form not primarily of a gas state and/or a liquid state.

Liquid product broadly refers to products and/or streams having a form not primarily of a gas state and/or a solid state. Some amount of entrained and/or retained gases and/or solids may be present in the liquid product.

Gas product broadly refers to products and/or streams having a form not primarily of a liquid state and/or a solid state.

According to one embodiment, the anionic clay includes hydrotalcite and/or hydrotalcite-like materials. Hydrotalcite broadly refers to double layered hydroxides, such as an ionic lamellar and/or plate like material. Hydrotalcite and hydrotalcite-like materials can include a positive charged metal hydroxide sheet balanced by a negative charged intercalated anion. Intercalation and/or interstitial broadly refers to inserting between and/or among existing elements and/or layers, such as may compensate a charge of a crystal between layers and/or determine a size of interlayer distances and/or basal spacing. Hydrotalcite may include the formula Mg₆A₁₂(OH)16CO₃.4H₂O.

The anionic clay can have any suitable chemical formula and/or composition, such as a formula of [M²⁺₍₁₋ₓ₎M³⁺ₓ(OH)₂]Aⁿ⁻_{x/n}*mH₂O. The variables in the chemical formula may include any suitable values and/or substituents. The M²⁺ can represent a divalent metal, such as Mg²⁺, Fe²⁺, Co²⁺, Cu²⁺, Ni²⁺, Zn²⁺, Ca²⁺, Sr²⁺, Ba²⁺, Mn²⁺, and/or the like. The M³⁺ can represent a trivalent metal, such as Al³⁺, Cr³⁺, Ga³⁺, La³⁺, Mn³⁺, Co³⁺, B³⁺, V³⁺, Ti³⁺, In³⁺, and/or the like. The M²⁺ and the M³⁺ can occupy lattice positions in brucite-like sheets and/or stacked sheets of octahedrons. The Aⁿ⁻ can represent an exchangeable anion located in a gallery between layers along with water molecules, such as the A represents F⁻, Cl⁻, I⁻, ClO₄⁻, NO₃⁻, ClO₃⁻, OH⁻; CO₃⁻, HVO₄²⁻, SO₄²⁻, WO₄²⁻, CrO₄²⁻, [Fe(CN)₆]⁴⁻, [SiO(OH)₃]⁻, MnO₄⁻, (PMo₁₂O₄₀)³⁻; (PW₁₂O₄₀)³⁻, [WZn_{3(H}₂O)(ZnW₉O₃₄)]¹²⁻, and/or the like. The x can represent a ratio of M³⁺/(M²⁺+M³⁺), such as between about 0.1 and about 1.0, between about 0.15 and about 0.5, between about 0.20 and about 0.33, and/or the like.

According to one embodiment, the M²⁺ represents Mg²⁺, and the M³⁺ represents Al³⁺. The Aⁿ⁻ represents CO₃²⁻, and the x has a value about ¼, and the m has a value of about ½.

The Aⁿ⁻ (intercalation anion) can include an organic anionic compound, an inorganic anionic compound, and/or the like. Desirably, the intercalation anion can form and/or make a pillared structure (like supported by columns), such as having a gap and/or a space between layers and/or sheets. Larger intercalation anions can increase a distance between the layers and/or the sheets. Without being bound by theory of operation, the anionic clays with gaps between layers can be more readily dispersed and and/or distributed into a feedstock, such as to break up and/or allow feedstock between the layers with additional surface area.

According to one embodiment, the anionic clay can include an aluminum magnesium carbonate. Optionally and/or additionally, the anionic clay can include a double layered metal hydroxide structure. The anionic clay can include a magnesium and aluminum hydroxide octahedral, such as interconnected at edges.

According to one embodiment, the invention may include petroleum coke made with any of the coking process additives disclosed herein. The petroleum coke may have any suitable characteristics. The petroleum coke may include shot coke, needle coke, sponge coke, anode grade coke, and/or the like. The petroleum coke may be useful for production of anodes used in aluminum melting, aluminum smelting, refining of bauxite ore, steel production, and/or the like.

Sponge coke broadly refers to generally isotropic and/or amorphous cokes, such as may include a visibly porous structure. The petroleum coke may contain any suitable amount of sponge coke, such as at least about 30 percent, at least about 40 percent, at least about 50 percent, at least about 60 percent, at least about 70 percent, at least about 80 percent, at least about 90 percent, and/or the like on a mass basis.

According to one embodiment, the invention can include a process of upgrading heavy hydrocarbons and producing petroleum coke. The process can include the step of mixing an anionic clay coking process additive with a hydrocarbon stream, and the step of coking the hydrocarbon stream to form a solid product, a liquid product, and a gas product.

The coking process additive of the process can include any of the features and/or characteristics of the coking process additive described herein (above).

Hydrocarbon broadly refers to any suitable compound containing predominantly and/or mostly carbon and hydrogen, such as may be derived from crude oil, petroleum, natural gas, coal, tar sands, shale, bitumen, and/or the like.

Conversion process broadly refers to any suitable method or steps to change and/or alter characteristics and/or features of molecules and/or compounds. Conversion processes generally, but not necessarily, include at least one chemical reaction, such as breaking long molecules into shorter molecules. Conversion process may also include separation and/or fractionation, such as distillation.

Upgrading broadly refers to any suitable step and/or action to improve and/or increase a desirability of and/or a value of a material and/or a stream. Upgrading processes can include thermal processes, catalytic processes, thermal-catalytic processes, and/or the like.

Heavy hydrocarbon broadly refers to fractions and/or materials having an at least relatively thick viscosity and/or a low API gravity, such as less than about 20 degrees of API gravity, less than about 10 degrees of API gravity, less than about 0 degrees of API gravity and/or the like. Suitable sources of heavy hydrocarbon material may include crude oil, crude atmospheric distillation bottoms, vacuum distillation bottoms, residue oils, bitumen, tar sands, decant oils, and/or the like.

Mixing broadly refers to combining and/or blending, such as by bringing into close physical contact. Mixing may be accomplished in any suitable manner and/or with any suitable process equipment. Mixing may include jet mixing, shear mixing, dry blending, injection, induction, ejection, conveying, stirring, agitating, dispersing, emulsifying, suspending, and/or the like.

The process may occur and/or take place in any suitable location, such as a in a delayed coking unit, a continuous coking unit, a fluid coking unit, and/or the like

The step of mixing the coking process additive can form any suitable concentration and/or amount, such as a stream with between about 10 parts per million and about 20,000 parts per million, between about 100 parts per million and about 10,000 parts per million, less than about 5,000 parts per million, and/or the like of the coking process additive on a mass basis

According to one embodiment, the anionic clay used in the process may include hydrotalcite and/or hydrotalcite-like materials. The anionic clay may include a chemical formula of [M²⁺₍₁₋ₓ₎M³⁺ₓ(OH)₂]Aⁿ⁻_{x/n}*mH₂O. The M²⁺ can include a divalent metal, and the M³⁺ can include a trivalent metal. The M²⁺ and M³⁺ can occupy lattice positions in brucite-like sheets. The Aⁿ⁻ can include an exchangeable anion located in a gallery between layers along with water molecules, and the x can include a ratio of M³⁺/(M²⁺+M³⁺).

Specifically, the M²⁺ can include Mg²⁺, and the M³⁺ can include Al³⁺. The Aⁿ⁻ can include CO₃²⁻, and the x can have a value of about ¼, and the m can include a value of about ½. Alternatively and/or additionally, the Aⁿ⁻ can include an organic anionic compound or an inorganic anionic compound to form a pillared structure.

The M²⁺ used in the process can include Mg²⁺, Fe²⁺, Co²⁺, Cu²⁺, Ni²⁺, Zn²⁺, Ca²⁺Sr²⁺, Ba²⁺, Mn²⁺, and/or the like. The M³⁺ used in the process can include Al³⁺, Cr³⁺, Ga³⁺, La³⁺, Mn³⁺, Co³⁺, B³⁺, V³⁺, Ti³⁺, In³⁺, and/or the like. The A used in the process can include F⁻, Cl⁻, I⁻, ClO₄⁻, NO₃⁻, ClO₃⁻, OH⁻; CO₃²⁻, HVO₄²⁻, SO₄²⁻, WO₄²⁻, CrO₄²⁻, [Fe(CN)₆]⁴⁻, [SiO(OH)₃]⁻; MnO₄⁻, (PMo₁₂O₄₀)³⁻; (PW₁₂O₄₀)³⁻, [WZn₃(H₂O)(ZnW₉O₃₄)]¹²⁻, and/or the like.

According to one embodiment, the anionic clay used in the process can include an aluminum magnesium carbonate, a double layered metal hydroxide structure, and/or a magnesium and aluminum hydroxide octahedra.

The process with the coking process additive can increase a liquid yield by any suitable amount over a process without the coking process additive, such as by at least about 0.2 weight percent, and/or the like.

The step of mixing can occur at any suitable location and/or point, such as before entering a furnace coil, after entering a furnace coil, at an entrance of a coke drum, within a coke drum by the additive being delivered to a top of a coke drum, and/or the like.

According to one embodiment, the process also includes the step of adding an asphaltene dispersant and/or a stabilization additive as a co-additive. Any suitable asphaltene dispersant may be used, such as those available from Champion Technologies Incorporated (Houston, Tex., U.S.A.), Nalco Company (Sugarland, Tex., U.S.A.), Baker-Petrolite (Baker Hughes Incorporated, Sugarland, Tex., U.S.A.), and Kurita Group (Tokyo, Japan). Asphaltene dispersants can operate at any suitable temperature, such as remaining at least partially stable at temperatures of at least about 200 degrees Celsius or higher while in hydrocarbon mixtures. The co-additive may be injected at any suitable location, such as those described with respect to the coking process additive. The co-additive may be added with or without the coking process additive.

The coking process additive may end up or become a part of any suitable product, such as the gas product, the liquid product, and/or the solid product. According to an embodiment, at least a portion of the coking process additive ends up in the solid product, such as the metal ions. In the alternative, all or substantially all the coking process additive ends up in the solid product. Without being bound by theory of operation, portions of the coking process additive may breakdown and/or decompose under coking conditions, such that liberated water and/or carbon dioxide may end up in the liquid product and/or the gas product.

The process with the additive may have any desirable affect and/or outcome, such as enhanced liquid product yield, lowered or reduced coke yield, changed coke product morphology, changed coke product density, enhanced coke product quality and value, lowered gas product yield, increased API gravity of a liquid product (made lighter), and/or the like. Several of the desirable affects may result in an increase in a coker unit capacity, such as to allow and/or provide for increasing a feed rate to the coker unit. Additionally and for refineries that may be coker capacity limited, ultimately additional crude oil capacity may be achieved using the processes and/or additives of the invention. Optionally, increased coke capacity can allow and/or provide for processing a heavier crude oil and/or crude slate (mixture), such as may provide increased refining margins and/or reduced raw material costs. The coking process additive may also improve unit operability and/or reliability, such as reducing coking and/or fouling of furnace tubes. Less fouling can allow longer run times between maintenance outages, for example. The coking process additive may also help reduce cycle time in a delayed coking process unit, thereby enhancing the process unit capacity and productivity.

Enhanced liquid product may include an increase of any suitable amount, such as between at least about 0.01 weight percent and about 10 weight percent, at least about 0.1 weight percent, and/or the like than a process without the coking process additive.

Lowered or reduced coke (solid) yield may include a decrease of any suitable amount (less coke generally causes more of higher value products, like liquid products), such as between about 0.01 weight percent and about 10 weight percent, at least about 0.1 weight percent, and/or the like than a process without the coking process additive.

Changed coke morphology may include making a different type and/or amount of a coke, such as reducing shot coke content, increasing shot coke content, increasing sponge coke content, increasing needle coke content, and/or the like than a process without the coking process additive.

Increased API gravity of a liquid product (made lighter) may include an increase of at least about 2 degrees of API gravity, an increase of at least about 5 degrees of API gravity, and increase of at least about 10 degrees of API gravity, and/or the like than a process without the coking process additive.

According to one embodiment, the coking process additive produces a liquid product with generally the same properties (suitable product characteristics and/or qualities) as processes without the coking process additive, such as API gravity and/or the like. The use of the coking process additive may allow increased capacity without a need to upgrade and/or revamp downstream process units.

Optionally and/or additionally, the process may include steam and/or water injection at a suitable location, such as before a furnace, after a furnace, before a coke drum, at a top of a coke drum, and/or the like. The steam and/or water injection may be at any suitable amount, such as zero percent, between about zero percent and about 25 percent, between about 0.1 percent and about 5 percent, at least about 0.5 percent, and/or the like of the feedstock on a mass basis. The steam and/or water may be added with or without the coking process additive.

According to one embodiment, the invention may include petroleum coke made with any of the processes of upgrading heavy hydrocarbons and producing petroleum coke disclosed herein. The petroleum coke may have any suitable characteristics.

According to one embodiment, the invention can include a process of thermally cracking heavy hydrocarbons. The process can include the step of mixing an anionic clay process additive with a hydrocarbon stream, and the step of heating the hydrocarbon stream to thermally crack at least a portion of the hydrocarbon stream.

Thermal broadly refers to relating to and/or caused by heat and/or temperature. Thermal processes may operate at any suitable temperature, such as at least about 100 degrees Celsius, between about ambient conditions and about 1,000 degrees Celsius, between about 250 degrees Celsius and about 750 degrees Celsius, between about 350 degrees Celsius and about 525 degrees Celsius, and/or the like.

Cracking broadly refers to breaking and/or splitting apart, such as into smaller molecular weight components.

The thermal cracking may occur in any suitable unit, plant, refinery process block, and/or the like, such as a visbreaking unit, or a residue fluidized catalytic cracking unit. In the alternative, the thermal cracking may occur in an oil field, in a bitumen field, in a natural gas field, on a platform in deep water, in an intermediate shipping location, in an intermediate storage location, and/or the like.

The anionic clay of the process additive can include hydrotalcite and/or an aluminum magnesium carbonate.

### EXAMPLES

Experiments were conducted in a delayed coking pilot plant with a coke drum and a furnace. The coke drum was an about 190 centimeter (75 inch) stainless steel tube with an about 7.6 centimeter (3 inch) internal diameter. Typical repeatability of product yields from the delayed coking batches in this pilot plant run within about 0.5 weight percent for both coke (solid) and liquid products.

A feedstock based on a vacuum residue from a large U.S. Midwest refinery operating on a crude slate of several different crudes was prepared and circulated through the furnace and into the coke drum for each example described below. Operating conditions included a coke drum pressure of 3.8 bar absolute, a temperature of 490 degrees Celsius at an entrance of the coke drum, a temperature differential between a bottom of the coke drum and a top of the coke drum of about 45 degrees Celsius, a feed rate of 3,600 grams per hour, and steam addition before the furnace of 40 grams per hour.

In examples where the additive was injected into the coke drum upstream of the furnace tube, the additive was thoroughly blended with the entire coker feed in the feed storage tank. In cases where the additive was injected into the coke drum downstream of the furnace tube, an additive cart was utilized. The additive cart included a 7.6 liter feed tank, a recirculation pump, and an injection metering pump. The solid additive was thoroughly blended with the same vacuum residue coker feed as the feedstock for the example and placed in the feed tank of the additive cart. When the additive cart was utilized for injecting the additive downstream of the furnace tube, the total flow of feed into the coke drum consisted of 90 weight percent from a main feed tank of the delayed coking system, and 10 weight percent from the additive tank.

Each example was run for about 4 hours before the coke drum was steam stripped for an hour at process temperature and cooled under slight vacuum for at least about 8 hours before opening.

Gaseous products (coker off-gases) were analyzed on-line by gas chromatography. Total liquid products from each of the coking pilot plant runs were combined and analyzed by gas chromatograph simulated distillation to quantify yields of various boiling range products from the coking process. As used below, gasoline has boiling point range of between about 28 degrees Celsius (82 degrees Fahrenheit) and about 221 degrees Celsius (430 degrees Fahrenheit). Diesel has a boiling point range of between about 221 degrees Celsius (430 degrees Fahrenheit) and about 343 degrees Celsius (650 degrees Fahrenheit). Gas oil has a boiling point range of greater than about 343 degrees Celsius (650 degrees Fahrenheit).

The coke was analyzed by elemental analysis. The coke was also analyzed for texture by an optical microscope. Morphology of the coke collected at various heights of the coke drum was visually analyzed. A total weight of the coke was measured by weighing the coke drum before and after a pilot plant run with the coke in it.

### Example 1

75 grams of a commercial sample of hydrotalcite from Sasol (Johannesburg, South Africa) was thoroughly blended with 2,500 grams of coker feed and placed in the feed tank of the additive cart at 177 degrees Celsius. This additive blend was injected into the delayed coking drum at an injection point a few centimeters below a base of the coke drum. The flow rate was adjusted such that 90 weight percent of the feed that was injected into the coke drum came from the main feed tank which did not contain any additive and 10 weight percent of the additive laden feed from the additive cart. The experiment was repeated for three runs and shown with averaged results.

### Comparative Example 1

Comparative Example 1 was conducted in the same manner as Example 1, but without addition of the hydrotalcite. The experiment was repeated for three runs and shown with averaged results.

### Example 2

75 grams of the hydrotalcite additive of Example 1 was thoroughly blended with 25,000 grams of the coker feed in the main feed tank. Example 2 was conducted in the same manner as Example 1, but without the additive cart. The feed with the additive passed through the furnace coil.

### Results

(weight percent)

| | | Comparative | |
|---|---|---|---|
| | Example 1 | Example 1 | Example 2 |
| Gas Product | 9.1 | 10.0 | 11.8 |
| Liquid Product | 63.5 | 60.8 | 60.2 |
| Solid Product | 27.5 | 29.2 | 28.0 |
| Morphology | sponge | sponge | sponge |
| Gasoline | 20.0 | 21.0 | 23.0 |
| Diesel | 35.0 | 33.0 | 35.0 |
| Gas Oil | 45.0 | 46.0 | 42.0 |

The example results demonstrate the coking process additive at low concentrations produced higher hydrocarbon liquid yields from delayed coking of the vacuum residue feedstock when added before the coke drum. The results also demonstrate that the coking process additive resulted in a similar liquid product distribution and coke morphology.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence, and/or limit of repetition for steps in a method or process, the drafter intends no implied order, number, sequence and/or limit of repetition for the steps to the scope of the invention, unless explicitly provided.

Regarding ranges, ranges are to be construed as including all points between the upper and lower values, such as to provide support for all possible ranges contained between the upper and lower values including ranges with no upper bound and/or lower bound.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A coking process additive, the additive comprising:
an anionic clay;
wherein the additive increases a liquid product yield.

2. The additive of claim 1, wherein the anionic clay comprises a hydrotalcite.

3. The additive of claim 1, wherein the anionic clay comprises a formula of [M²⁺₍₁₋ₓ₎M³⁺ₓ(OH)_{2]A}ⁿ⁻_{x/n}*mH₂O, wherein:
the M²⁺ comprises a divalent metal;
the M³⁺ comprises a trivalent metal;
the M²⁺ and M³⁺ occupy lattice positions in brucite-like sheets;
the Aⁿ⁻ comprises an exchangeable anion located in a gallery between layers along with water molecules; and
the x comprises a ratio of M³⁺/(M²⁺+M³⁺).

4. The additive of claim 3, wherein:
the M²⁺ comprises Mg²⁺;
the M³⁺ comprises Al³⁺;
the Aⁿ⁻ comprises CO₃^{2 -};
the x comprises about ¼; and
the m comprises about ½.

5. The additive of claim 3, wherein the Aⁿ⁻ comprises an organic anionic compound or an inorganic anionic compound to form a pillared structure.

6. The additive of claim 3, wherein:
the M²⁺ comprises Mg²⁺, Fe²⁺, Co²⁺, Cu²⁺, Ni²⁺, Zn²⁺, Ca²⁺, Sr²⁺, Ba²⁺, Mn²⁺, and combinations thereof;
the M³⁺ comprises Al³⁺, Cr³⁺, Ga³⁺, La³⁺, Mn³⁺, Co³⁺, B³⁺, V³⁺, Ti³⁺, In³⁺, and combinations thereof; and
the A comprises F⁻, Cl⁻, I⁻, ClO₄⁻, NO₃⁻, ClO₃⁻, OH⁻; CO₃²⁻, HVO₄²⁻, SO₄²⁻, WO₄²⁻, CrO₄²⁻, [Fe(CN)₆]⁴⁻, [SiO(OH)₃]⁻; MnO₄⁻, (PMo₁₂O₄₀)³⁻; (PW₁₂O₄₀)³⁻, [WZn₃(H₂O)(ZnW₉O₃₄)]¹²⁻, and combinations thereof.

7. The additive of claim 1, wherein the anionic clay comprises an aluminum magnesium carbonate.

8. The additive of claim 1, wherein the anionic clay comprises a double layered metal hydroxide structure.

9. The additive of claim 1, wherein the anionic clay comprises a magnesium and aluminum hydroxide octahedra.

10. The additive of claim 1, wherein the coking process additive increases the liquid product yield by at least about 0.2 weight percent.

11. Petroleum coke made by with the coking process additive of claim 1.

12. A process of upgrading heavy hydrocarbons and producing petroleum coke, the process comprising:
mixing a coking process additive with a hydrocarbon stream; and
coking the hydrocarbon stream to form a solid product, a liquid product, and a gas product;
wherein the coking process additive comprises an anionic clay.

13. The process of claim 12, wherein the process occurs in a delayed coking unit, a continuous coking unit, or a fluid coking unit.

14. The process of claim 12, wherein the step of mixing the coking process additive forms a stream with between about 10 parts per million and about 20,000 parts per million of the coking process additive on a mass basis.

15. The process of claim 12, wherein the step of coking comprises a temperature of between about 400 degrees Celsius and about 550 degrees Celsius.

16. The process of claim 12, wherein the anionic clay comprises hydrotalcite.

17. The process of claim 12, wherein the anionic clay comprises a formula of [M²⁺₍₁₋ₓ₎M³⁺ₓ(OH)_{2]A}ⁿ⁻_{x/n}*mH₂O, wherein:
the M²⁺ comprises a divalent metal;
the M³⁺ comprises a trivalent metal;
the M²⁺ and M³⁺ occupy lattice positions in brucite-like sheets;
the Aⁿ⁻ comprises an exchangeable anion located in a gallery between layers along with water molecules, and
the x comprises a ratio of M³⁺/(M²⁺+M³⁺).

18. The process of claim 17, wherein:
the M²⁺ comprises Mg²⁺;
the M³⁺ comprises Al³⁺;
the Aⁿ⁻ comprises CO₃²⁻;
the x comprises about ¼; and
the m comprises about ½.

19. The process of claim 17, wherein the Aⁿ⁻ comprises an organic anionic compound or an inorganic anionic compound to form a pillared structure.

20. The process of claim 17, wherein:
the M²⁺ comprises Mg²⁺, Fe²⁺, Co²⁺, Cu²⁺, Ni²⁺, Zn²⁺, Ca²⁺, Sr²⁺, Ba²⁺, Mn²⁺, and combinations thereof;
the M³⁺ comprises Al³⁺, Cr³⁺, Ga³⁺, La³⁺, Mn³⁺, Co³⁺, B³⁺, V³⁺, Ti³⁺, In³⁺, and combinations thereof; and
the A comprises F⁻, Cl⁻, I⁻, ClO₄⁻, NO₃⁻, ClO₃⁻, OH⁻; CO₃²⁻, HVO₄²⁻, SO₄²⁻, WO₄²⁻, CrO₄²⁻, [Fe(CN)_{6]}⁴⁻, [SiO(OH)_{3]}⁻; MnO₄^{-, PMo}₁₂O₄₀)³⁻; (PW₁₂O₄₀)³⁻, [WZn₃(H₂O)(ZnW₉O₃₄)]¹²⁻, and combinations thereof.

21. The process of claim 12, wherein the anionic clay comprises an aluminum magnesium carbonate.

22. The process of claim 12, wherein the anionic clay comprises a double layered metal hydroxide structure.

23. The process of claim 12, wherein the anionic clay comprises a magnesium and aluminum hydroxide octahedra.

24. The process of claim 12, wherein the coking process additive increases a liquid product yield by at least about 0.2 weight percent.

25. The process of claim 12, wherein the step of mixing occurs before entering a furnace coil, after entering a furnace coil, at an entrance of a coke drum, or within a coke drum by the additive being delivered to a top of a coke drum.

26. The process of claim 12, further comprising adding an asphaltene dispersant as a co-additive.

27. The process of claim 12, wherein at least a portion of the coking process additive ends up in the solid product.

28. Petroleum coke made by with the process of claim 12.

29. A process of thermally cracking heavy hydrocarbons, the process comprising:
mixing a process additive with a hydrocarbon stream; and
heating the hydrocarbon stream to thermally crack at least a portion of the hydrocarbon stream;
wherein the process additive comprises an anionic clay.

30. The process of claim 29, wherein the process occurs in a visbreaking unit or a residue fluidized catalytic cracking unit.

31. The process of claim 29, wherein the anionic clay comprises hydrotalcite.

32. The process of claim 29, wherein the anionic clay comprises an aluminum magnesium carbonate.
